(19) United States
(12) Patent Application Publication
(10) Pub. No.: US 2013/0140887 A1
(43) Pub. Date: Jun. 6, 2013

(54) CLUSTERING METHOD, OPTIMIZATION METHOD USING THE SAME, POWER SUPPLY CONTROL DEVICE

(71) Applicants: Jun Yamasaki, Moriguchi-shi (JP); Ryuichiro Tominaga, Moriguchi-shi (JP)

(72) Inventors: Jun Yamasaki, Moriguchi-shi (JP); Ryuichiro Tominaga, Moriguchi-shi (JP)

(73) Assignee: SANYO ELECTRIC CO., LTD., Osaka (JP)

(21) Appl. No.: 13/698,146

(22) PCT Filed: Dec. 8, 2011
(86) PCT No.: PCT/JP2011/078406

§ 371 Date: Nov. 15, 2012

(30) Foreign Application Priority Data
Dec. 9, 2010 (JP) 2010-274302

(51) Int. Cl. H02J 4/00

(52) U.S. Cl. CPC H02J 4/00
USPC 307/11

(57) ABSTRACT

The present invention is a method for performing clustering of sizes of loads of a power supply system with history data for each predetermined period as objects to be classified, wherein the method is such that, for each of the history data, subtraction processing is performed thereupon in which the amounts of specific loads which have been identified as loads of the power supply system are deducted, whereupon clustering is performed for each of the history data for which the subtraction processing has been performed thereupon as the objects to be classified.

### TECHNICAL FIELD

The present invention relates to a method for clustering historical data related to a load, an optimization method for optimizing, by using the same, a method for controlling a power supply system, and a power supply control device.

### BACKGROUND ART

Conventionally, with respect to a power supply system that supplies electric power to a load connected thereto, processing of optimizing a method for controlling the power supply system is performed. To cite one example of said processing, based on historical data on a load magnitude, a variation pattern of the load magnitude is identified and put to use.

In said processing, with respect to historical data pieces obtained at every predetermined cycle (for example, every 24 hours) as objects to be categorized, which are presumed to be analogous in history to each other, clustering may be performed. In this case, identification of such a variation pattern is performed for each cluster, and thus more detailed optimization processing can be achieved.

For example, in a case where, by using historical data obtained over a time period of one year, control operations to be performed over a time period of one year are optimized collectively at a time, optimization for every single day of the year, in fact, might not be achieved. A solution to this problem could be that historical data obtained over a time period of one year is separated into data pieces each corresponding to a single day of the year, which are then categorized by clustering into clusters, and optimization is performed for each of the clusters.

### LIST OF CITATIONS

### Patent Literature

Patent Document 1: JP-A-2004-30269

### SUMMARY OF THE INVENTION

### Technical Problem

By the way, in a case where, as one of loads connected to a power supply system, a specific load of a level not negligible in clustering occurs on an irregular basis, it becomes difficult to appropriately perform the above-described clustering. In this application, the above expression “a specific load occurs” may be used to explain that the specific load becomes a load of a power supply system.

For example, if historical data pieces indicating similar tendencies vary in the status of occurrence of the specific load (for example, the number of times of occurrence, occurrence timing, and so on), they are categorized into different clusters. As a result, the number of resulting clusters is extremely increased to require a considerable amount of time for optimization processing.

In view of the above-described problem, it is an object of the present invention to provide a clustering method in which, even in a case where a specific load occurs on an irregular basis, clustering of historical data on a load magnitude can be performed more appropriately. Furthermore, it is also an object of the present invention to provide an optimization method regarding a method for controlling a power supply system, which uses said clustering method, and a power supply control device.

### Solution to the Problem

A clustering method according to the present invention is a method for performing clustering with respect to pieces of historical data regarding a load magnitude of a power supply system, which are obtained at every predetermined cycle, as objects to be categorized. In the method, with respect to each of the historical data pieces, subtraction processing of subtracting the magnitude of a specific load identified as becoming a load of the power supply system is performed, and with respect to the historical data pieces after having been subjected to the subtraction processing as the objects to be categorized, clustering is performed. Further, a specific load history that is a history corresponding to a time period in which the specific load has been the load of the power supply system is recorded in advance, and based on the specific load history, a part of each of the historical data pieces with respect to which the subtraction processing should be performed is recognized.

Furthermore, a clustering method according to the present invention is a method for performing clustering with respect to pieces of historical data regarding a load magnitude of a power supply system, which are obtained at every predetermined cycle, as objects to be categorized. In the method, with respect to each of the historical data pieces, subtraction processing of subtracting the magnitude of a specific load identified as becoming a load of the power supply system is performed, and with respect to the historical data pieces after having been subjected to the subtraction processing as the objects to be categorized, clustering is performed. Further, a part of each of the historical data pieces that satisfies a condition that an increase and a decrease in the load magnitude within a given period of time exceed their predetermined threshold values is recognized as a part of the each of the historical data pieces with respect to which the subtraction processing should be performed.

Furthermore, an optimization method according to the present invention is a method for optimizing a method for controlling the power supply system with respect to each cluster obtained by the above-described clustering method.

Furthermore, a power supply control device according to the present invention performs clustering in accordance with the above-described clustering method and includes: a load historical data storage portion that acquires and stores the historical data; and a clustering execution portion that performs the clustering by using the historical data stored in the load historical data storage portion. The power supply control device is configured to control the power supply system in accordance with a control method identified based on a result of the clustering performed by the clustering execution portion.

### Advantageous Effects of the Invention

With the clustering method according to the present invention, even in a case where a specific load occurs on an irregular basis, clustering of historical data on a load magnitude can be performed more appropriately.

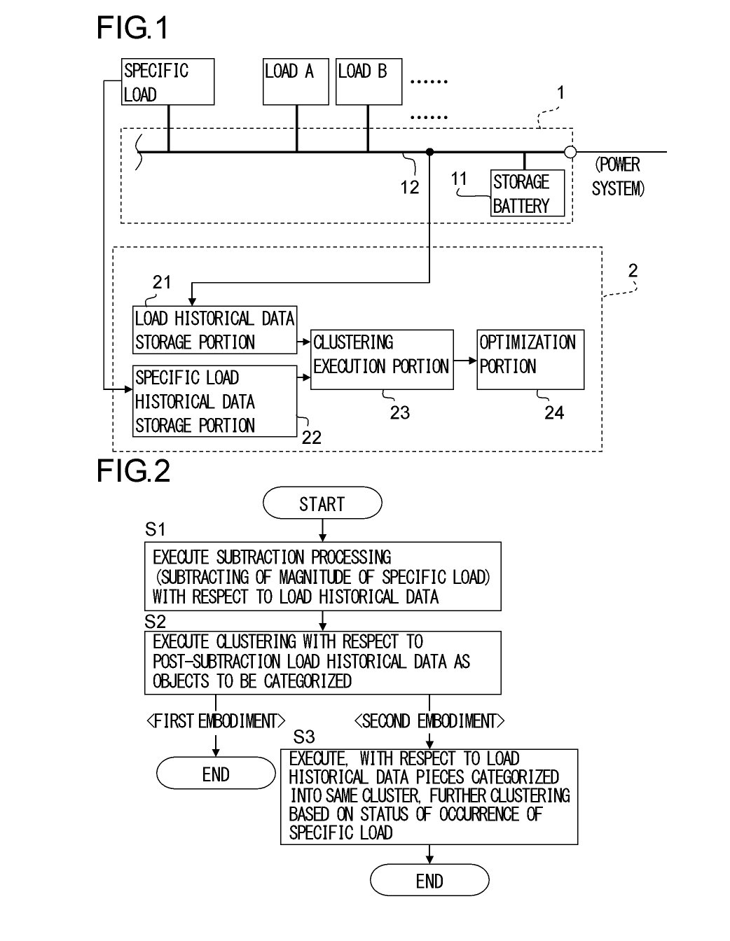

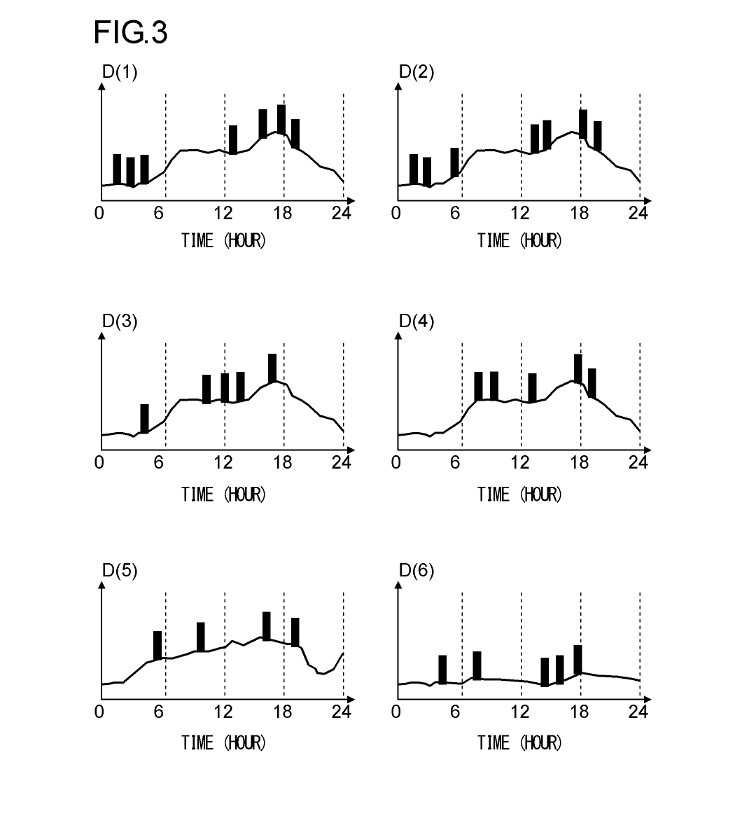

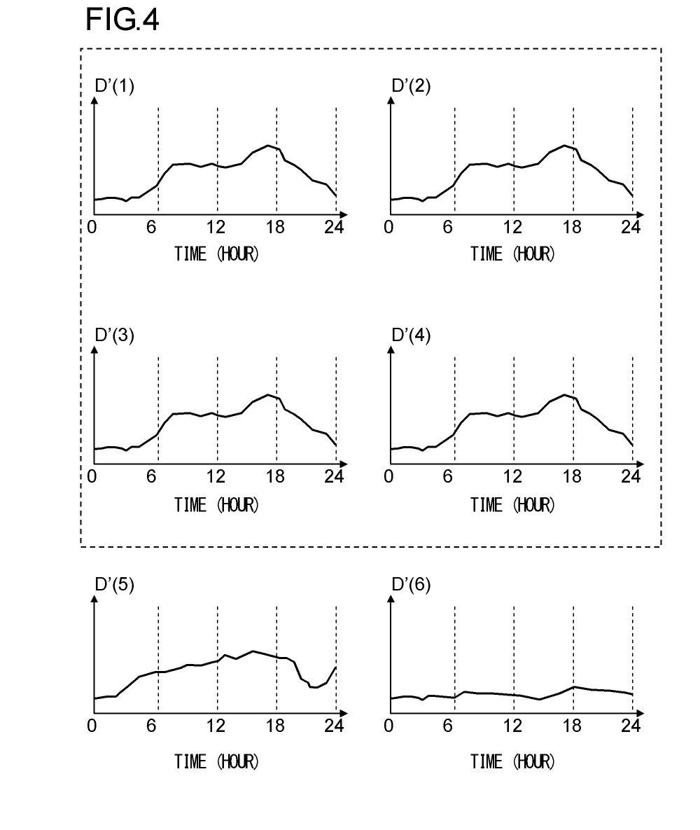

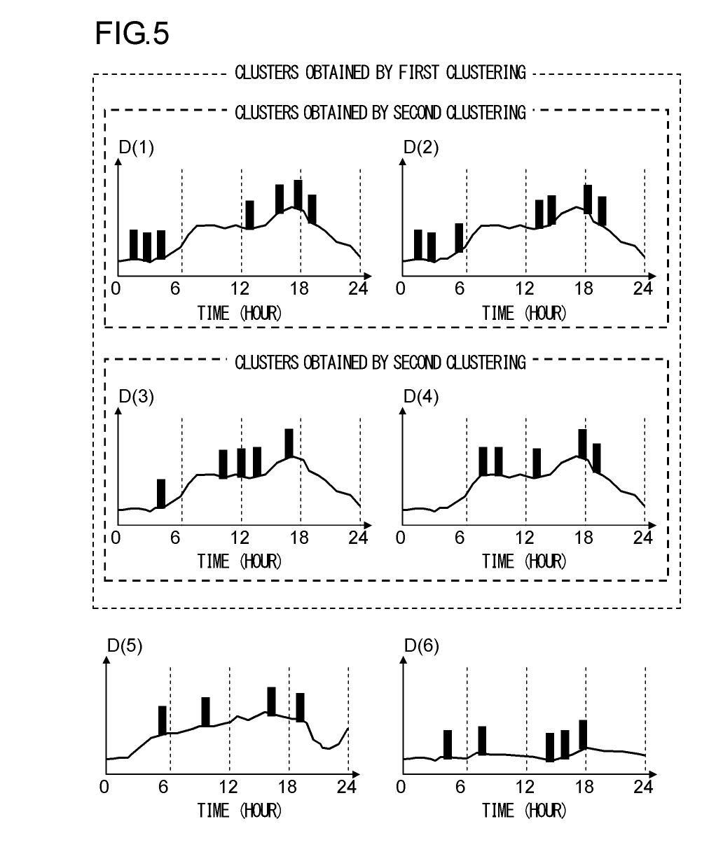

### BRIEF DESCRIPTION OF DRAWINGS

[FIG. 1] A structural view regarding a power supply system and an optimization device according to an embodiment of the present invention.

[FIG. 2] A flow chart related to a clustering procedure according to the embodiment of the present invention.

[FIG. 3] An explanatory view related to the clustering procedure according to the embodiment of the present invention.

[FIG. 4] An explanatory view related to the clustering procedure according to the embodiment of the present invention.

[FIG. 5] An explanatory view related to a clustering procedure according to an embodiment of the present invention.

### DESCRIPTION OF EMBODIMENTS

Hereinafter, embodiments of the present invention will be described by exemplarily referring to Embodiments 1 and 2.

### 1. First Embodiment

[Regarding Configurations, Etc. Of Power Supply System and Optimization Device]

First, a description is given of a first embodiment of the present invention. FIG. 1 is a structural view of a power supply system 1 and an optimization device 2 according to this embodiment. As shown in this figure, said power supply system 1 includes a storage battery 11 and a power supply line 12.

The storage battery 11 is configured to be chargeable and dischargeable, such that it can be charged with electric power of, for example, an existing power system (commercial power source) and can also be discharged for supplying electric power to a load. Charging and discharging of the storage battery 11 are controlled in accordance with a control method optimized by the optimization device 2.

The power supply line 12 is connected to the storage battery 11 and to a power system and is configured so that a plurality of loads (in FIG. 1, a specific load, a load A, and a load B are shown as examples) can be connected thereto. The power supply line 12 supplies the loads with electric power obtained from the storage battery 11 and from the power system at, for example, a constant voltage. As the magnitude of a load (in a case where there are a plurality of loads, the sum of the magnitudes of the loads) on the power supply line 12 increases, electric power supplied from the power supply system is increased.

As described above, the loads of the power supply system 1 include the specific load. The specific load is a load specific in that it becomes a load of the power supply system 1 on an irregular basis (for example, temporarily at random timing). One example of the specific load is a load for charging (particularly, quick charging) of an EV (electric vehicle). Typically, charging of an EV is performed by a user of the EV or the like at arbitrary timing, i.e. on an irregular basis.

Furthermore, hereinafter, regarding the loads of the power supply system 1, all the loads other than the specific load may be referred to collectively as a “base load”. The specific load has a magnitude at not less than a given percentage of a standard magnitude of the base load, which is such a magnitude as to affect after-mentioned optimization of a control method (particularly, clustering of load historical data).

Furthermore, as shown in FIG. 1, the optimization device 2 includes a load historical data storage portion 21, a specific load historical data storage portion 22, a clustering execution portion 23, an optimization portion 24, and so on.

The load historical data storage portion 21 monitors a power state of the power supply line 12 and acquires and stores historical data regarding a load magnitude of the power supply system 1 (hereinafter, referred to as “load historical data”). The load historical data is made up of separate data pieces obtained at every predetermined cycle (in this embodiment, as one example, at every 24 hours), respectively, and each of these load historical data pieces is stored together with accompanying information such as a date, a day of the week, and so on. Preferably, load historical data pieces obtained over as long a time period as possible (for example, over a period of about one year) are stored.

The specific load historical data storage portion 22 acquires, by a predetermined method, data of a history corresponding to a time period in which the specific load has been a load of the power supply system 1 (for example, a date and a time of each of the beginning and end of the time period in which the specific load has been the load) (hereinafter, referred to as “specific load historical data”) and stores the data. The specific load historical data storage portion 22 can detect a time period in which the specific load has been a load of the power supply system 1 by, for example, receiving a connection signal (signal indicating that the specific load is connected to the power supply system 1) from the specific load.

The clustering execution portion 23 executes clustering of load historical data pieces that have been stored up to the present time. Concrete processing steps executed by the clustering execution portion 23 will be described again in more detail.

The optimization portion 24 optimizes, with respect to each cluster obtained through the clustering processing performed by the clustering execution portion 23, a method for controlling charging and discharging of the storage battery 11 (this method can be regarded also as one example of a method for controlling the power supply system 1). As a procedure for optimizing the method for controlling the power supply system with respect to each cluster, there are various types of procedures, and any one of them can be adopted. As one example, this embodiment adopts a procedure described below.

The optimization portion 24 identifies, with respect to each cluster as described above, a variation pattern regarding the loads of the power supply system 1 (hereinafter, may be referred to simply as a “variation pattern”). The variation pattern is identified as a pattern of an average variation in load magnitude in a past history (track record), for example, as an average of load historical data pieces categorized into the same cluster.

The variation pattern may be a pattern obtained in consideration of the magnitude of the specific load or without consideration thereof (i.e. a pattern obtained on the assumption that the specific load does not occur). Since data pieces categorized into the same cluster are analogous to each other, typically, the variation pattern is approximate to each of the load historical data pieces in that cluster.

Assuming that a load magnitude of the power supply system 1 varies in accordance with the variation pattern, the optimization portion 24 optimizes the method for controlling charging and discharging of the storage battery 11 so that optimum charging and discharging can be achieved in light of a predetermined policy (for example, using a predetermined algorithm). With the control method thus optimized, for example, when, based on the variation pattern, a substantial load increase is expected to occur in the near future, discharging of the storage battery 11 is restricted so that a sufficient stored power amount can be secured, and thus even when a load increase occurs, power supply can be performed appropriately.

As described earlier, the control method optimized in the above-described manner is reflected in the control of charging and discharging of the storage battery 11. As a cluster, based on which the control method to be reflected in the control of charging and discharging of the storage battery 11 is optimized, for example, a cluster into which the highest number of data pieces are categorized could be used. This, however, is merely one example, and a cluster of any other type may be used as necessary.

### [Regarding Clustering Procedure]

Next, with reference to the flow chart shown in FIG. 2, a description is given of a procedure of clustering load historical data that is executed by the clustering execution portion 23.

For the sake of easier understanding, said description is exemplarily directed to a case where, as shown in FIG. 3, there are six load historical data pieces D(1) to D(6) (corresponding to six days). In FIG. 3, the horizontal axis indicates a time, and the vertical axis indicates a load magnitude. Each colored section shown in FIG. 3 indicates the magnitude of the specific load.

First, with respect to each of the load historical data pieces stored in the load historical data storage portion 21, the clustering execution portion 23 performs processing (subtraction processing) of subtracting the magnitude of the specific load (Step S1). The load historical data pieces after having been subjected to the subtraction processing (hereinafter, may be referred to as “post-subtraction load historical data”) can be regarded as load historical data pieces regarding only the base load.

As for a part of each of the load historical data pieces with respect to which the subtraction processing should be performed (i.e. a part corresponding to a time period in which the specific load has been a load of the power supply system 1), such a part is recognized based on specific load historical data stored in the specific load historical data storage portion 22.

As an alternative scheme to the above, a part of a graph of each of the load historical data pieces that bulges to a degree satisfying a predetermined condition (for example, a condition that an increase and a decrease in load magnitude within a given period of time exceed their predetermined threshold values) may be recognized as a part of each of the load historical data pieces with respect to which the subtraction processing should be performed. In a case where the base load tends to vary sufficiently gently compared with the specific load (conversely, in a case where the specific load varies abruptly compared with the base load), this scheme can be used for recognition of a part of each of the load historical data pieces with respect to which the subtraction processing should be performed. In a case of using this scheme, it is possible to omit, for example, storing specific load historical data.

By the processing step at Step S1, as shown in FIG. 4, the load historical data pieces D(1) to D(6) are changed to post-subtraction load historical data pieces D′(1) to D′(6), respectively.

Next, with respect to the post-subtraction load historical data pieces D′(1) to D′(6), the clustering execution portion 23 executes clustering (Step S2). As is already known, clustering is processing of categorizing, in accordance with a predetermined analogy judgment standard, objects to be categorized into clusters. That is, objects to be categorized, which are analogous to each other, are categorized into the same cluster.

By the processing step at Step S2, for example, as shown by being enclosed with a broken line in FIG. 4, among the post-subtraction load historical data pieces D′(1) to D′(6), D′(1) to D′(4) are categorized into the same cluster, and D′(5) and D′(6) are not categorized thereto. In this manner, clustering of load historical data (post-subtraction load historical data) is achieved.

As described above, with the clustering procedure of this embodiment, clustering can be performed in consideration only of the base load among the loads of the power supply system 1 and without consideration of the magnitude of the specific load. Thus, with said procedure, clustering can be executed more appropriately.

For example, each of the load historical data pieces (in a state before being subjected to the subtraction processing) shown in FIG. 3 includes the magnitude of the specific load that occurs on an irregular basis, thus exhibiting an extremely low degree of analogy to another. Because of this, executing clustering in this state leads to a trouble such as that the number of resulting clusters is extremely increased.

In this respect, with the clustering procedure of this embodiment, regardless of the status of occurrence of the specific load, data pieces analogous to each other in the status of variation of the base load are categorized into the same cluster. Hence, the above-described trouble can be avoided.

### 2. Second Embodiment

Next, a description is given of a second embodiment of the present invention. The second embodiment is basically the same as the first embodiment, except for a difference in procedure of clustering load historical data. In describing the second embodiment, emphasis is placed on the difference from the first embodiment, and descriptions of components identical to those in the first embodiment may be omitted.

Similarly to the case of the first embodiment, by way of concrete examples, the following describes a procedure of clustering load historical data that is performed in the second embodiment. Also in the second embodiment, the procedural steps at Steps S1 to S2 are executed.

It is therefore herein assumed that the processing steps up to Step S2 previously described with regard to the first embodiment have already been done (as shown in FIG. 4, post-subtraction load historical data pieces D′(1) to D′(4) have been categorized into the same cluster), and procedural steps performed subsequently thereto will be described.

With respect to load historical data pieces that have been categorized into the same cluster by the processing step at Step S2 (first clustering), the clustering execution portion 23 performs more detailed clustering (second clustering) based on the status of occurrence of the specific load (Step S3).

The status of occurrence of the specific load refers to, for example, the number of times the specific load has become a load of the power supply system 1 (number of times of occurrence), timing at which the specific load has become the load (occurrence timing), the amount of the specific load, and so on. Herein, with attention focused on the number of times of occurrence as the status of occurrence of the specific load, the processing step at Step S3 is assumed to be a processing step in which data pieces identical to each other in the number of times of occurrence of the specific load are categorized into the same cluster.

By the processing step at Step S3, with respect to load historical data pieces D(1) to D(4) already categorized into the same cluster, more detailed clustering is performed based on the number of occurrence of the specific load. As a result, as shown in FIGS. 5, D(1) and D(2) (in each of which the specific load has occurred seven times) are categorized into the same cluster, and separately therefrom, D(3) and D(4) (in each of which the specific load has occurred five times) are categorized into another same cluster.

As described above, with the clustering procedure of this embodiment, after clustering similar to that in the case of the first embodiment has been performed, in consideration further of the magnitude of the specific load regarding each of load historical data pieces categorized into the same cluster, more detailed clustering is performed. Thus, in a case where the status of occurrence of the specific load largely varies, load historical data pieces, which would be categorized into the same cluster when no consideration is given to the specific load, can be categorized into different clusters.

Hence, for example, in a case where it is desired that, if the status of occurrence of the specific load largely varies, different control methods be adopted depending thereon, optimization of the control method can be performed more appropriately.

### 3. Others

As described thus far, the optimization device 2 according to the embodiments of the present invention is configured so that, for the purpose of optimization of the method for controlling charging and discharging of the storage battery 11 (optimization of the method for controlling the power supply system 1), it executes clustering of load historical data pieces.

A clustering method of the first embodiment performed by the optimization device 2 is a method for clustering load historical data pieces obtained at every 24 hours (every predetermined cycle) as objects to be categorized, in which with respect to each of the load historical data pieces, processing (subtraction processing) of subtracting the magnitude of the pre-identified specific load that becomes a load of the power supply system 1 is performed, and with respect to the load historical data pieces after having been subjected to the subtraction processing as the objects to be categorized, the clustering is performed.

Furthermore, the clustering method performed by the optimization device 2 is a method in which specific load historical data is recorded in advance, and based on the specific load historical data, a part of each of the load historical data pieces with respect to which subtraction processing should be performed is recognized. Furthermore, a clustering method of another aspect performed by the optimization device 2 is a method in which a part of each of the load historical data pieces that satisfies a condition that an increase and a decrease in load magnitude within a given period of time exceed their predetermined threshold values is recognized as a part of each of the load historical data pieces with respect to which subtraction processing should be performed.

With the clustering method performed by the optimization device 2, even in a case where the specific load occurs on an irregular basis, clustering of historical data on a load magnitude can be performed more appropriately. For example, an extreme increase in the number of resulting clusters is suppressed, thereby allowing clustering to be performed in a reduced amount of time.

A clustering method of the second embodiment performed by the optimization device 2 is a method in which, with respect to load historical data pieces categorized into the same cluster by the clustering method according to the first embodiment, more detailed clustering is performed based on the status of occurrence of the specific load.

Hence, for example, in a case where it is desired that, if the status of occurrence of the specific load largely varies, different control methods be adopted depending thereon, optimization of the control method can be performed more appropriately.

The optimization device 2 may be configured so that it not only identifies a method for controlling charging and discharging of the storage battery 2 based on a result of the above-described clustering but also controls the charging and discharging of the storage battery 2 by the control method thus identified. In this case, the optimization device 2 can be used as a power supply control device that controls the power supply system 1.

While the foregoing has discussed the embodiments of the present invention, the scope of the present invention is not limited thereto. Furthermore, the embodiments of the present invention may be variously modified without departing from the spirit of the present invention.

### INDUSTRIAL APPLICABILITY

The present invention is applicable to, for example, a device that controls a power supply system.

### LIST OF REFERENCE SYMBOLS

1 power supply system
2 optimization device
11 storage battery
12 power supply line
21 load historical data storage portion
22 specific load historical data storage portion
23 clustering execution portion
24 optimization portion
D(1) to D(6) load historical data pieces
D′(1) to D′(6) post-subtraction load historical data pieces

1. A clustering method for performing clustering with respect to pieces of historical data regarding a load magnitude of a power supply system, which are obtained at every predetermined cycle, as objects to be categorized, the method comprising:
performing, with respect to each of the historical data pieces, subtraction processing of subtracting a magnitude of a pre-identified specific load that becomes a load of the power supply system; and
performing clustering with respect to the historical data pieces after having been subjected to the subtraction processing as the objects to be categorized,
wherein a specific load history that is a history corresponding to a time period in which the specific load has been the load of the power supply system is recorded in advance, and
based on the specific load history, a part of each of the historical data pieces with respect to which the subtraction processing should be performed is recognized.

2. A clustering method for performing clustering with respect to pieces of historical data regarding a load magnitude of a power supply system, which are obtained at every predetermined cycle, as objects to be categorized, the method comprising:
performing, with respect to each of the historical data pieces, subtraction processing of subtracting a magnitude of a pre-identified specific load that becomes a load of the power supply system; and
performing clustering with respect to the historical data pieces after having been subjected to the subtraction processing as the objects to be categorized,
wherein a part of each of the historical data pieces that satisfies a condition that an increase and a decrease in the load magnitude within a given period of time exceed their predetermined threshold values is recognized as a part of the each of the historical data pieces with respect to which the subtraction processing should be performed.

3-9. (canceled)

10. A clustering method, comprising:
performing, with respect to historical data pieces categorized into a same cluster by the clustering method according to claim 1, more detailed clustering based on a status of occurrence of the specific load.

11. A clustering method, comprising:
performing, with respect to historical data pieces categorized into a same cluster by the clustering method according to claim 2, more detailed clustering based on a status of occurrence of the specific load.

12. The clustering method according to claim 1, wherein
the specific load becomes a load of the power supply system on an irregular basis.

13. The clustering method according to claim 2, wherein
the specific load becomes a load of the power supply system on an irregular basis.

14. The clustering method according to claim 1, wherein
the specific load has a magnitude at not less than a given percentage of a standard of a total magnitude of all loads of the power supply system other than the specific load

15. The clustering method according to claim 2, wherein
the specific load has a magnitude at not less than a given percentage of a standard of a total magnitude of all loads of the power supply system other than the specific load

16. The clustering method according to claim 1, wherein
the specific load is a load for charging an EV.

17. The clustering method according to claim 2, wherein
the specific load is a load for charging an EV.

18. An optimization method for optimizing a method for controlling the power supply system with respect to each cluster obtained by the clustering method according to claim 1.

19. An optimization method for optimizing a method for controlling the power supply system with respect to each cluster obtained by the clustering method according to claim 2.

20. A power supply control device that performs clustering in accordance with the clustering method according to claim 1, comprising:
a load historical data storage portion that acquires and stores the historical data; and
a clustering execution portion that performs the clustering by using the historical data stored in the load historical data storage portion,
wherein the power supply control device controls the power supply system in accordance with a control method identified based on a result of the clustering performed by the clustering execution portion.

21. A power supply control device that performs clustering in accordance with the clustering method according to claim 2, comprising:
a load historical data storage portion that acquires and stores the historical data; and
a clustering execution portion that performs the clustering by using the historical data stored in the load historical data storage portion,
wherein the power supply control device controls the power supply system in accordance with a control method identified based on a result of the clustering performed by the clustering execution portion.

22. The power supply control device according to claim 20, wherein
the power supply system supplies electric power to the load by utilizing discharging of a storage battery, and
the power supply control device controls the power supply system by controlling charging and discharging of the storage battery.

23. The power supply control device according to claim 21, wherein
the power supply system supplies electric power to the load by utilizing discharging of a storage battery, and
the power supply control device controls the power supply system by controlling charging and discharging of the storage battery.
